(19) United States
(12) Patent Application Publication
(10) Pub. No.: US 2017/0192653 A1
(43) Pub. Date: Jul. 6, 2017

(54) DISPLAY AREA ADJUSTING METHOD AND ELECTRONIC DEVICE

(71) Applicants: Le Holdings (Beijing) Co., Ltd., Beijing (CN); Lemobile Information Technology (Beijing) Co., Ltd., Beijing (CN)

(72) Inventor: Jinxin Hao, Beijing (CN)

(73) Assignees: Le Holdings (Beijing) Co., Ltd., Beijing (CN); Lemobile Information Technology (Beijing) Co., Ltd., Beijing (CN)

(21) Appl. No.: 15/247,706

(22) Filed: Aug. 25, 2016

Related U.S. Application Data
(63) Continuation of application No. PCT/CN2016/087665, filed on Jun. 29, 2016.

(30) Foreign Application Priority Data
Dec. 31, 2015 (CN) 201511032486.8

(51) Int. Cl. G06F 3/0484; G06F 3/0488

(52) U.S. Cl. CPC G06F 3/04845; G06F 3/04883

(57) ABSTRACT

Disclosed are a display area adjusting method and device. The method includes the following steps: acquiring a sliding track of a user in a display area; judging whether the shape of the sliding track is consistent with a preset shape; determining a display range of the sliding track if the shape of the sliding track is consistent with the preset shape; and reducing the size of the display area and displaying the reduced display area within the display range.

### CROSS-REFERENCE TO RELATED APPLICATIONS

This application is a continuation of International Application No. PCT/CN2016/087665, filed on Jun. 29, 2016, which is based upon and claims priority to Chinese Patent Application No. 201511032486.8, filed on Dec. 31, 2015, the entire contents of which are incorporated herein by reference.

### TECHNICAL FIELD

The present disclosure relates to the field of control of smart terminals, and more particularly to a display area adjusting method and electronic device.

### BACKGROUND

In the prior art, smart terminals have become indispensable equipment in daily life and work. In particular, with the improvement and development of the functions of smart phones, large-size screens have increasingly dominated. It is well known that the screen of a smart phone serves not only as a display device, but also a control device, and yet large-screen smart phones have become increasingly unsuitable for single-handed operations by users.

The existing solution lies in providing the user with a variety of predetermined screen display area sizes. In a general state, the display area is the same as the screen size (full-screen display), and when the user needs to operate the smart phone with single hand, the user may select another predetermined size, and then the terminal reduces the display area to the predetermined size, which may be ½, ⅓, etc. of the screen size, and moves the entire reduced display area to a corner of the screen. The defect of the existing page control solution lie in that due to the fact that the system only provides a limited number of alternative sizes to the user without considering the area that can be actually covered by the user's fingers, page size cannot be dynamically adjusted of actual situations, thereby leading to a poor flexibility.

### SUMMARY

Thus, the present disclosure provides a display area adjusting method and an electronic device that overcome the defect of poor flexibility of the display area adjusting solution in the prior art.

One objective of the embodiments of present disclosure is to provide a display area adjusting method, comprising the following steps: acquiring a sliding track of a user in a display area; judging whether the shape of the sliding track is consistent with a preset shape; determining a display range of the sliding track if the shape of the sliding track is consistent with the preset shape; and reducing the size of the display area and displaying the reduced display area within the display range.

In a class of the embodiments, preferably, determining a display range of the sliding track includes selecting a coordinate point P1 with a coordinate value of (X_{L}, Y_{L}) along the sliding track and a coordinate point P2 with a coordinate value of (X_{K}, Y_{K}) at a corner of the current display area; and determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

In a class of the embodiments, preferably, the preset shape is arc-shape.

In a class of the embodiments, preferably, selecting a coordinate point P1 with the coordinate values of (X_{L}, Y_{L}) along the sliding track and a coordinate point P2 with the coordinate values of (X_{K}, Y_{K}) at a corner of the current display area includes selecting the coordinate point P2 at a corner of the current display area of a start point and an end point of the sliding track; and selecting the coordinate point P1 furthest away from the coordinate point P2 along the sliding track.

In a class of the embodiments, preferably, the preset shape is a closed shape, and determining a display range of the sliding track includes selecting a closed area formed by the sliding track; and determining the display range within the closed area of proportional information of the display area.

Another objective of the embodiments of the present disclosure is to provide an electronic device, comprising one or more processors; and a memory communicably connected with the at least one processor for storing instructions executable by the at least one processor, wherein execution of the instructions by the at least one processor causes the at least one processor to acquire a sliding track of a user in a display area; judge whether the shape of the sliding track is consistent with a preset shape; determine a display range of the sliding track if the shape of the sliding track is consistent with the preset shape; and reduce the size of the display area and displaying the reduced display area within the display range.

In a class of the embodiments, preferably, determining a display range of the sliding track includes selecting a coordinate point P1 with a coordinate value of (X_{L}, Y_{L}) along the sliding track and a coordinate point P2 with a coordinate value of (X_{K}, Y_{K}) at a corner of the current display area; and determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

In a class of the embodiments, preferably, the preset shape is arc-shape.

In a class of the embodiments, preferably, selecting a coordinate point P1 with the coordinate values of (X_{L}, Y_{L}) along the sliding track and a coordinate point P2 with the coordinate values of (X_{K}, Y_{K}) at a corner of the current display area includes selecting the coordinate point P2 at a corner of the current display area of a start point and an end point of the sliding track; and selecting the coordinate point P1 furthest away from the coordinate point P2 along the sliding track.

In a class of the embodiments, preferably, the preset shape is a closed shape, and determining a display range of the sliding track includes selecting a closed area formed by the sliding track; and determining the display range within the closed area of proportional information of the display area.

A further objective of the embodiments of the present disclosure is to provide a non-transitory computer-readable storage medium storing executable instructions that, when executed by an electronic device with a touch-sensitive display, cause the electronic device to acquire a sliding track of a user in a display area; judge whether the shape of the sliding track is consistent with a preset shape; determine a display range of the sliding track if the shape of the sliding track is consistent with the preset shape; and reduce the size of the display area and displaying the reduced display area within the display range.

In a class of the embodiments, preferably, determining a display range of the sliding track comprises selecting a coordinate point P1 with a coordinate value of (X_{L}, Y_{L}) along the sliding track and a coordinate point P2 with a coordinate value of (X_{K}, Y_{K}) at a corner of the current display area; and determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

In a class of the embodiments, preferably, the preset shape is arc-shape.

In a class of the embodiments, preferably, selecting a coordinate point P1 with the coordinate values of (X_{L}, Y_{L}) along the sliding track and a coordinate point P2 with the coordinate values of (X_{K}, Y_{K}) at a corner of the current display area comprises selecting the coordinate point P2 at a corner of the current display area of a start point and an end point of the sliding track; and selecting the coordinate point P1 furthest away from the coordinate point P2 along the sliding track.

In a class of the embodiments, preferably, the preset shape is a closed shape, and determining a display range of the sliding track comprises selecting a closed area formed by the sliding track; and determining the display range within the closed area of proportional information of the display area.

In the display area adjusting method and electronic device provided by the embodiments of the present disclosure, the size of an area that can be reached by single hand of a user may be determined of a sliding track of the user, and during this process, mistaken operations of the user are prevented by judging whether the sliding track of the user is consistent with a preset shape, a new display range is then determined of the sliding track consistent with the preset shape, and finally, the size of the original display area is reduced of the size of the new display range and the reduced display area is fitted within the above display range. With this solution, the page size can be dynamically adjusted of the actual situations of the user and therefore the solution has high flexibility and convenience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a display area adjusting method provided by one embodiment of the present disclosure;

FIG. 2 is a schematic diagram of a process of display area adjustment in one embodiment of the present disclosure;

FIG. 3 is a schematic diagram of a process of display area adjustment in another embodiment of the present disclosure;

FIG. 4 is a schematic structural diagram of a display area adjusting device provided by one embodiment of the present disclosure;

FIG. 5 is a schematic diagram of the hardware configuration of the electronic device provided by one embodiment of the present disclosure.

### DETAILED DESCRIPTION

In order to clearly describe objectives, the technical solutions and advantages of the present disclosure. A clear and complete description of the technical solutions in the present disclosure will be given below, in conjunction with the accompanying drawings in the embodiments of the present disclosure. Apparently, the embodiments described below are a part, but not all, of the embodiments of the present disclosure

### Embodiment 1

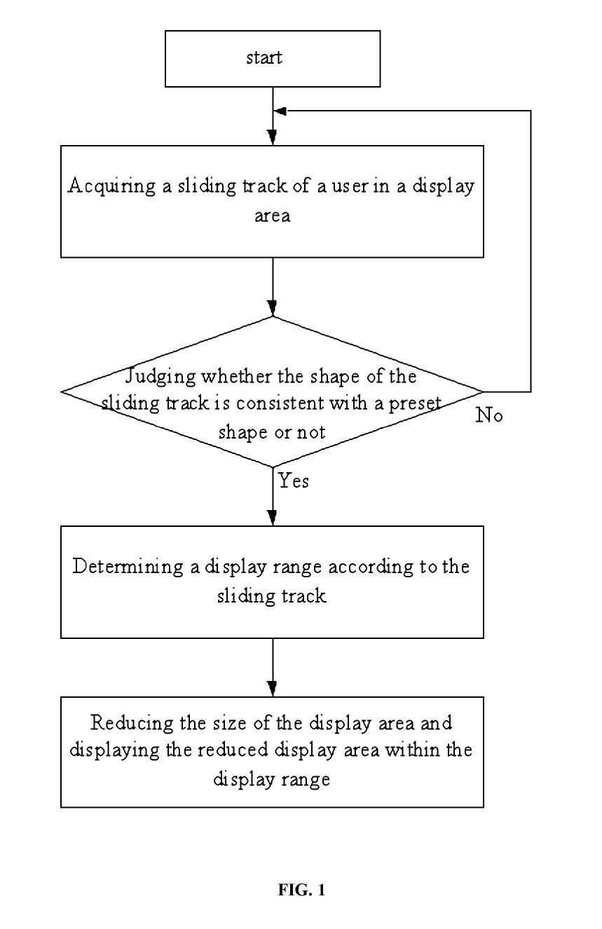

One embodiment of the present disclosure provides a display area adjusting method, which can be executed by a smart terminal having a touch screen. The method, as shown in FIG. 1 includes the following steps:

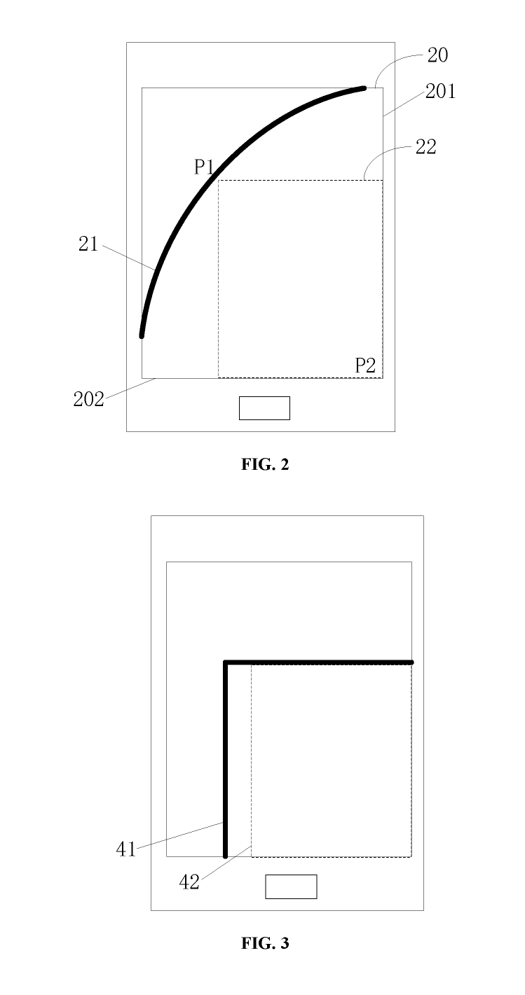

S1, acquiring a sliding track of a user in a display area. FIG. 2 shows a scenario where a user operates a terminal with single hand. The terminal is a large-screen smart phone. The user holds the phone with his right hand and performs operations in a current display area 20 with the fingers of the right hand, and thus the terminal may acquire an arc-shaped sliding track 21.

S2, judging whether the shape of the sliding track is consistent with a preset shape. There may be many preset shapes, for example, a closed shape, a linear shape and an arc shape are possible. This method is described in details herein by taking the arc shape as an example, and those other preset shapes will be introduced later hereinafter;

Wherein, there are various factors that are taken into consideration when judging whether the shape of the operation track of the user meets predetermined requirements. For example, the operation time duration of the user, the total length of the track, the angular characteristics of the track and the like can be used as conditions of the judgment. Addition of the abovementioned judgment step can effectively avoid unnecessary subsequent processing for mistaken operations of the user. That is to say, the step S3 is executed only if the shape of the sliding track is consistent with the preset shape; otherwise, this operation of the user is ignored and the method returns to further monitoring for the next sliding track of the user.

S3, determining a display range of the sliding track. For sliding tracks of different shapes, ways of determining a display range are different. The display area determined in this step is the range in which the adjusted display area is finally displayed; as a result, the display area determined here should be completely covered by a single hand of the user, regardless of the shape of the sliding track. Specifically, the single-hand sliding track provided by the user before has already been enough to be used as reference data for determining the display range. For example, if the track is arc-shaped, then it represents that all coordinate points which can be reached by single hand of the user should be located within the arc-shaped sliding track 21, a right side 201 of the display area and a lower side 202 of the display area. There are also many methods for determining the display range based on the three types of data, and one preferred embodiment will be introduced in details below. For a linear track, its principle is similar to the arc-shaped track; and for a closed area, the closed area may be directly used as the display range. As shown in FIG. 2, the display range 22 can be determined after the step S3.

S4, reducing the size of the display area and displaying the reduced display area within the display range. To completely fit the display area within the display range 22, the original display area should be reduced of an aspect ratio, so that the reduced display area is fitted within the display range 22.

Of the display area adjusting solution provided by the present disclosure, the size of an area that can be reached by single hand of a user may be determined of a sliding track of the user, and during this process, mistaken operations of the user are prevented by judging whether the sliding track of the user is consistent with a preset shape, a new display range is then determined of of the sliding track consistent with the preset shape, and finally, the size of the original display area is reduced of the size of the new display range and the reduced display area is fitted within the above display range. With this solution, the page size can be dynamically adjusted of the actual situations of the user and therefore the solution has high flexibility and convenience.

As a preferred embodiment, the above step S3 may include the following sub-steps:

S31, selecting a coordinate point P1 with a coordinate value of (X_{L}, Y_{L}) along the sliding track and a coordinate point P2 with a coordinate value of (X_{K}, Y_{K}) at a corner of the current display area. There are many ways of selecting the coordinate point P1, and for different shapes, different selection ways may be used.

S32, determining the display range by using the coordinate point P1 and the coordinate point P2, in the determined display range, the coordinate values of all coordinate points are (Xₙ, Yₙ), where Xₙ is located between X_{L} and X_{K}, and Yₙ is located between Y_{L} and Y_{K}. As shown in FIG. 3, the horizontal coordinates of all pixel points within the display range 22 are X₀ . . . Xₙ, and the vertical coordinates are Y₀ . . . Yₙ. Given that the lower left corner of the terminal is an origin (0, 0), then X_{L}≦X₀ . . . Xₙ≦X_{K}, Y_{K}≦Y₀ . . . Yₙ≦Y_{L}.

In the abovementioned preferred solution, the display range is determined only of two points, so high calculation efficiency is achieved.

As described above, for sliding tracks of different shapes, ways of determining the display range are different. In this case, an arc-shaped track is taken as a preferred way, because the user typically slides the screen with his thumb when operating with single hand and thumb sliding is more likely to create an arc-shaped track. Therefore, it is closer to the user's habit of operation that arc shape is used as the preset shape, and convenience may be further improved.

The way of determining the display range by selecting coordinate points along the arc-shaped track will be further detailed below with reference to FIG. 2. That is, the above step S31 may include the following sub-steps:

S311, selecting the coordinate point P2 at a corner of the current display area of a start point and an end point of the sliding track. This step aims to determine the user operates the screen with his left hand or right hand, and specifically the following recognition operation may be performed as follows: among four corners of the screen, the upper right endpoint of the screen is closest to the upper endpoint of the arc-shaped track 21 and the lower left endpoint of the screen is closest to the lower endpoint of the arc-shaped track 21, and accordingly from the distances between the start point of the track and the corners of the screen, it can be determined that the user operates the screen with the right hand, and then the coordinate point P2 at the lower right corner of the display area 20 is further selected.

S312, selecting the coordinate point P1 furthest away from the coordinate point P2 along the sliding track. For an arc shape, it is obvious that the point along the arc shape furthest away from the lower right corner is the furthest location that can be reached by the thumb of the user.

In the abovementioned preferred solution, the operation hand of the user is judged of the sliding track at first and then a corner of the original display area is selected of the judgment result and the corner is a location that can be currently reached by the user. Afterwards, on the basis of the corner, a point along the sliding track that is furthest away from the corner is found, and this point is the furthest location that can be currently reached by the finger of the user. Then the display range is determined of the above two points, which accordingly can ensure that all the locations within the display range can be reached by the user with single hand and the size of this range is maximized.

For a linear track, its principle is similar to that of the above arc-shaped track, so the description thereof will not be repeated here. The sliding track of a closed shape will be introduced below with reference to FIG. 3. As for the closed shape/area, there are also many situations, e.g. the shape itself may be a round shape, a rectangular shape or other irregular shapes, and many ways of forming closure exist as well, for example, the track itself may be closed, or the track together with the original display area (edges) forms a closure. The closed rectangular area which is formed by the track together with the original display area is taken as an example for illustrative purposes in this embodiment, and it will be appreciated by those skilled in the art that as for the other situations mentioned above, their principles are similar.

That is, the above step S3 may include the following steps:

S31′, selecting a closed area 41 formed by the sliding track; and

S32′, determining the display range 42 within the closed area 41 of proportional information of the display area. The proportion of the display area described herein refers to the proportion of the original display area, e.g. the screen proportion. Not only the finally-determined display range 42 should be fitted within the closed area 41, but also its proportion is preferably the same as the proportion of the original display area. The operation of determining the display range in the abovementioned solution has higher efficiency and also more accuracy. No conflict exists among subsequent processing steps corresponding to, for example, the above described preset arc shape, preset linear shape, preset closed shape and preset irregular shape, so during practical use, all of the above preset shapes may be provided simultaneously and depending on an actual sliding track of the user, a respective subsequent processing is used.

### Embodiment 2

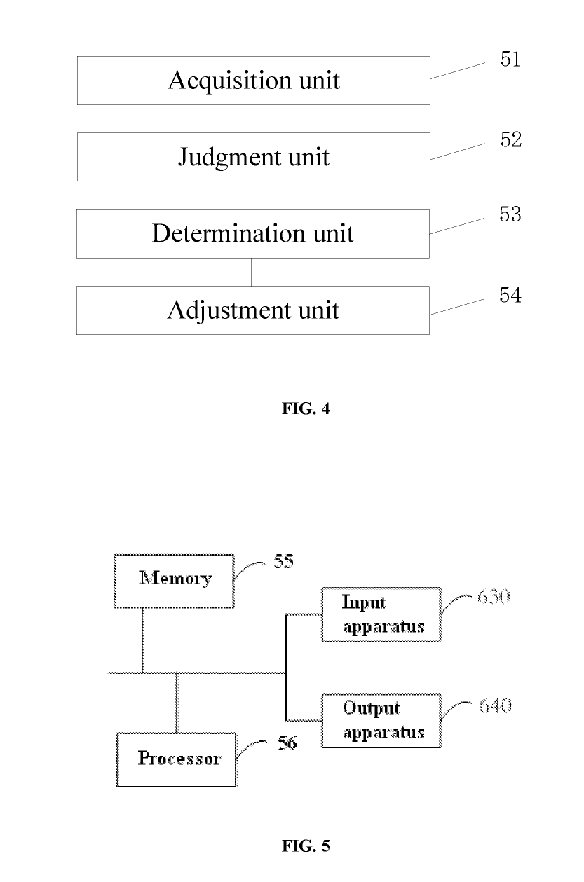

Another embodiment of the present disclosure also provides a display area adjusting device, which can be arranged in a smart terminal having a touch screen. The device, as shown in FIG. 4, includes an acquisition unit 51 for acquiring a sliding track of a user in a display area; a judgment unit 52 for judging whether the shape of the sliding track is consistent with a preset shape; a determination unit 53 for determining a display range of the sliding track if the shape of the sliding track is consistent with the preset shape; and an adjustment unit 54 for reducing the size of the display area and displaying the reduced display area within the display range.

Of the display area adjusting solution provided by the present disclosure, the size of an area that can be reached by single hand of a user can be determined of a sliding track of the user, and during this process, mistaken operations of the user are prevented by judging whether the sliding track of the user is consistent with a preset shape, a new display range is then determined of the sliding track consistent with the preset shape, and finally, the size of the original display area is reduced of the size of the new display range and the reduced display area is fitted within the above display range. With this solution, the page size can be adjusted dynamically of the actual situations of the user and therefore the solution has high flexibility and convenience.

Preferably, the determination unit 53 includes a selection unit for selecting a coordinate point P1 with a coordinate value of (X_{L}, Y_{L}) along the sliding track and a coordinate point P2 with a coordinate value of (X_{K}, Y_{K}) at a corner of the current display area; and a sub-determination unit for determining the display range by using the coordinate point P1 and the coordinate point P2; in the determined display range, the coordinate values of all coordinate points are (Xₙ, Yₙ), where Xₙ is located between X_{L} and X_{K}, and Yₙ is located between Y_{L} and Y_{K}.

In the abovementioned preferred solution, the display range is determined only of two points, so high calculation efficiency is achieved.

Preferably, the preset shape is arc-shaped. It is closer to the user's habit of operation that an arc shape is used as the preset shape, and convenience can be further improved. The selection unit includes a first selection unit for selecting the coordinate point P2 at a corner of the current display area of a start point and an end point of the sliding track; and a second selection unit for selecting the coordinate point P1 furthest away from the coordinate point P2 along the sliding track.

In the abovementioned preferred solution, the operation hand of the user is judged of the sliding track at first and then a corner of the original display area is selected of the judgment result, and the corner is a location that can be currently reached by the user. Afterwards, on the basis of the corner, a point along the sliding track that is furthest away from the corner is found, and this point is the furthest location that can be currently reached by the finger of the user. Then the display range is determined of the above two points, which accordingly can ensure that all the locations within the display range can be reached by single hand of the user and the size of this range is maximized.

Preferably, the preset shape is a closed shape, and the determination unit includes a selection unit for selecting a closed area formed by the sliding track; a sub-determination unit for determining the display range within the closed area of proportional information of the display area.

The operation of determining the display range in the abovementioned preferred solution is higher in efficiency and also more accurate.

### Embodiment 3

The present embodiment provides a non-transitory computer-readable storage medium storing executable instructions that, when executed by an electronic device with a touch-sensitive display, cause the electronic device to acquire a sliding track of a user in a display area; judge whether the shape of the sliding track is consistent with a preset shape; determine a display range of the sliding track if the shape of the sliding track is consistent with the preset shape; and reduce the size of the display area and displaying the reduced display area within the display range;

Preferably, determining a display range of the sliding track comprises selecting a coordinate point P1 with a coordinate value of (X_{L}, Y_{L}) along the sliding track and a coordinate point P2 with a coordinate value of (X_{K}, Y_{K}) at a corner of the current display area; and determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

Preferably, the preset shape is arc-shaped.

Preferably, selecting a coordinate point P1 with the coordinate values of (X_{L}, Y_{L}) along the sliding track and a coordinate point P2 with the coordinate values of (X_{K}, Y_{K}) at a corner of the current display area comprises selecting the coordinate point P2 at a corner of the current display area of a start point and an end point of the sliding track; and selecting the coordinate point P1 furthest away from the coordinate point P2 along the sliding track.

Preferably, the preset shape is a closed shape, and determining a display range of the sliding track comprises selecting a closed area formed by the sliding track; and determining the display range within the closed area of proportional information of the display area.

### Embodiment 4

FIG. 5 is a schematic diagram of the hardware configuration of the electronic device provided by the embodiment, which performs the display area adjusting method. As shown in FIG. 5, the electronic device includes: one or more processors 56 and a memory 55, wherein one processor 56 is shown in FIG. 6 as an example.

The electronic device that performs the display area adjusting method further includes an input apparatus 630 and an output apparatus 640.

The processor 56, the memory 55, the input apparatus 630 and the output apparatus 640 may be connected via a bus line or other means, wherein connection via a bus line is shown in FIG. 6 as an example.

The memory 55 is a non-transitory computer-readable storage medium that can be used to store non-transitory software programs, non-transitory computer-executable programs and modules, such as the program instructions/modules corresponding to the display area adjusting method of the embodiments of the present disclosure (e.g. the acquisition unit 41, the focus recognition unit 42 the monitoring unit 43, the recognition unit, and the execution unit shown in the FIG. 4). The processor 56 executes the non-transitory software programs, instructions and modules stored in the memory 55 so as to perform various function application and data processing of the server, thereby implementing the Display area adjusting method of the above-mentioned method embodiments

The memory 55 includes a program storage area and a data storage area, wherein, the program storage area can store an operation system and application programs required for at least one function; the data storage area can store data generated by use of the display area adjusting device. Furthermore, the memory 55 may include a high-speed random access memory, and may also include a non-volatile memory, e.g. at least one magnetic disk memory unit, flash memory unit, or other non-volatile solid-state memory unit. In some embodiments, optionally, the memory 55 includes a remote memory accessed by the processor 56, and the remote memory is connected to the display area adjusting device via network connection. Examples of the aforementioned network include but not limited to internet, intranet, LAN, GSM, and their combinations.

The input apparatus 630 receives digit or character information, so as to generate signal input related to the user configuration and function control of the display area adjusting device. The output apparatus 640 includes display devices such as a display screen.

The one or more modules are stored in the memory 55 and, when executed by the one or more processors 56, perform the display area adjusting method of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:
1) Mobile communication devices: The characteristic of this type of device is having a mobile communication function with a main goal of enabling voice and data communication. This type of terminal device includes: smartphones (such as iPhone), multimedia phones, feature phones, and low-end phones.
2) Ultra-mobile personal computer devices: This type of device belongs to the category of personal computers that have computing and processing functions and usually also have mobile internet access features. This type of terminal device includes: PDA, MID, UMPC devices, such as iPad.
3) Portable entertainment devices: This type of device is able to display and play multimedia contents. This type of terminal device includes: audio and video players (such as iPod), handheld game players, electronic books, intelligent toys, and portable GPS devices.
4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.
5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

What is claimed is:

1. A display area adjusting method, comprising the following steps:
acquiring a sliding track of a user in a display area;
judging whether the shape of the sliding track is consistent with a preset shape;
determining a display range of the sliding track if the shape of the sliding track is consistent with the preset shape; and
reducing the size of the display area and displaying the reduced display area within the display range.

2. The method of claim 1, wherein determining a display range of the sliding track comprises:
selecting a coordinate point P1 with a coordinate value of (X_{L}, Y_{L}) along the sliding track and a coordinate point P2 with a coordinate value of (X_{K}, Y_{K}) at a corner of the current display area; and
determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

3. The method of claim 2, wherein the preset shape is arc-shape.

4. The method of claim 3, wherein that selecting a coordinate point P1 with the coordinate values of (X_{L}, Y_{L}) along the sliding track and a coordinate point P2 with the coordinate values of (X_{K}, Y_{K}) at a corner of the current display area comprises:
selecting the coordinate point P2 at a corner of the current display area of a start point and an end point of the sliding track; and
selecting the coordinate point P1 furthest away from the coordinate point P2 along the sliding track.

5. The method of claim 1, wherein the preset shape is a closed shape, and determining a display range of the sliding track comprises:
selecting a closed area formed by the sliding track; and
determining the display range within the closed area of proportional information of the display area.

6. An electronic device, comprising a memory communicably connected with the at least one processor for storing instructions executable by the at least one processor, wherein execution of the instructions by the at least one processor causes the at least one processor to
acquire a sliding track of a user in a display area;
judge whether the shape of the sliding track is consistent with a preset shape;
determine a display range of the sliding track if the shape of the sliding track is consistent with the preset shape; and
reduce the size of the display area and displaying the reduced display area within the display range.

7. The electronic device of claim 6, wherein determining a display range of the sliding track comprises:
selecting a coordinate point P1 with a coordinate value of (X_{L}, Y_{L}) along the sliding track and a coordinate point P2 with a coordinate value of (X_{K}, Y_{K}) at a corner of the current display area; and
determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

8. The electronic of claim 7, wherein the preset shape is arc-shape.

9. The electronic device of claim 8, wherein selecting a coordinate point P1 with the coordinate values of (X_{L}, Y_{L}) along the sliding track and a coordinate point P2 with the coordinate values of (X_{K}, Y_{K}) at a corner of the current display area comprises:
selecting the coordinate point P2 at a corner of the current display area of a start point and an end point of the sliding track; and
selecting the coordinate point P1 furthest away from the coordinate point P2 along the sliding track.

10. The device of claim 9, wherein the preset shape is a closed shape, and determining a display range of the sliding track comprises:
selecting a closed area formed by the sliding track; and
determining the display range within the closed area of proportional information of the display area.

11. A non-transitory computer-readable storage medium storing executable instructions that, when executed by an electronic device, cause the electronic device to:
acquire a sliding track of a user in a display area;
judge whether the shape of the sliding track is consistent with a preset shape;
determine a display range of the sliding track if the shape of the sliding track is consistent with the preset shape; and
reduce the size of the display area and displaying the reduced display area within the display range.

12. The non-transitory computer-readable storage medium of claim 11, wherein
determining a display range of the sliding track comprises:
selecting a coordinate point P1 with a coordinate value of (X_{L}, Y_{L}) along the sliding track and a coordinate point P2 with a coordinate value of (X_{K}, Y_{K}) at a corner of the current display area; and
determining the display range by using the coordinate point P1 and the coordinate point P2, in the determined display range, the coordinate values of all coordinate points are (Xₙ, Yₙ), wherein Xₙ is located between X_{L} and X_{K}, and Yₙ is located between Y_{L} and Y_{K}.

13. The non-transitory computer-readable storage medium of claim 12, wherein the preset shape is arc-shape.

14. The non-transitory computer-readable storage medium of claim 13, wherein selecting a coordinate point P1 with the coordinate values of (X_{L}, Y_{L}) along the sliding track and a coordinate point P2 with the coordinate values of (X_{K}, Y_{K}) at a corner of the current display area comprises:
selecting the coordinate point P2 at a corner of the current display area of a start point and an end point of the sliding track; and
selecting the coordinate point P1 furthest away from the coordinate point P2 along the sliding track.

15. The non-transitory computer-readable storage medium of claim 14, wherein the preset shape is a closed shape, and determining a display range of the sliding track comprises:
selecting a closed area formed by the sliding track; and
determining the display range within the closed area of proportional information of the display area.
